(19) United States
(12) Patent Application Publication
(10) Pub. No.: US 2018/0357546 A1
(43) Pub. Date: Dec. 13, 2018

(54) OPTIMIZING TREE-BASED CONVOLUTIONAL NEURAL NETWORKS

(71) Applicant: INTERNATIONAL BUSINESS MACHINES CORPORATION, ARMONK, NY (US)

(72) Inventors: TUNG D. LE, Ichikawa (JP); TARO SEKIYAMA, Urayasu (JP); KUN ZHAO, Funabashi (JP)

(21) Appl. No.: 15/903,600

(22) Filed: Feb. 23, 2018

Related U.S. Application Data
(63) Continuation of application No. 15/617,737, filed on Jun. 8, 2017.

(51) Int. Cl. G06N 3/08; G06N 3/04

(52) U.S. Cl. CPC G06N 3/082; G06N 3/04

(57) ABSTRACT

A computer-implemented method for optimizing neural networks for receiving plural input data having a form of a tree or a Directed Acyclic Graph (DAG). Finding a common node included in at least two of the input data in common. Reconstructing the plural input data by sharing the common node.

### BACKGROUND

The present invention relates to optimizing tree-based convolutional neural networks.

Recently, various techniques have been known regarding neural networks. For example, convolutional neural networks (CNNs) have been explored.

### BRIEF SUMMARY

Additional aspects and/or advantages will be set forth in part in the description which follows and, in part, will be apparent from the description, or may be learned by practice of the invention.

According to an embodiment of the present invention, there is provided a computer-implemented method for optimizing neural networks for receiving a plurality of input data having a form of a tree or a Directed Acyclic Graph (DAG). The method includes finding a common node included in at least two of the input data in common. The method further includes reconstructing the plural input data by sharing the common node.

According to another embodiment of the present invention, there is provided a system for processing a plurality of input data having a form of a tree or a Directed Acyclic Graph (DAG) with convolutional neural networks. The system includes a first processor, a second processor, and a third processor. The first processor is configured to generate a graph by combining the plurality of input data while sharing a common node included in at least two of the input data in common. The second processor is configured to extract feature information on each node from the combined input data while keeping a structure of the combined input data using the graph in a convolutional layer included in the convolutional neural networks. The third processor is configured to conduct a process with a fully connected layer based on the extracted feature information.

According to yet another embodiment of the present invention, there is provided a computer program product for processing a plurality of input data having a form of a tree or a Directed Acyclic Graph (DAG) with convolutional neural networks. The computer program product includes a computer readable storage medium having program instructions embodied therewith. The program instructions are executable by a computer to cause the computer to find a common node included in at least two of the input data in common. The program instructions are executable by a computer to cause the computer to combine the plural input data while sharing the common node to generate a graph to be used for a convolutional layer of the convolutional neural networks. The graph is the tree or the DAG. The graph includes nodes and information on the respective nodes. The nodes include the common node.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 depicts a configuration of convolutional neural networks according to an exemplary embodiment of the present invention.

FIG. 2 depicts a block diagram showing a configuration of an information processing system utilizing the convolutional neural networks.

FIG. 3 depicts a configuration of the tree-based convolutional neural networks (TBCNN).

FIGS. 4A and 4B depict structures of the trees including the same subtree.

FIG. 5 depicts a block diagram showing a configuration of the processer.

FIG. 6 is a flowchart of a process to generate the TBCNN.

FIG. 7 is a flowchart of a process to generate a tree-based convolutional (TBC) layer.

FIG. 8 depicts a structure of a tree generated by combining the trees of FIGS. 4A and 4B.

FIG. 9 depicts an example of a hardware configuration of the information processing system.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

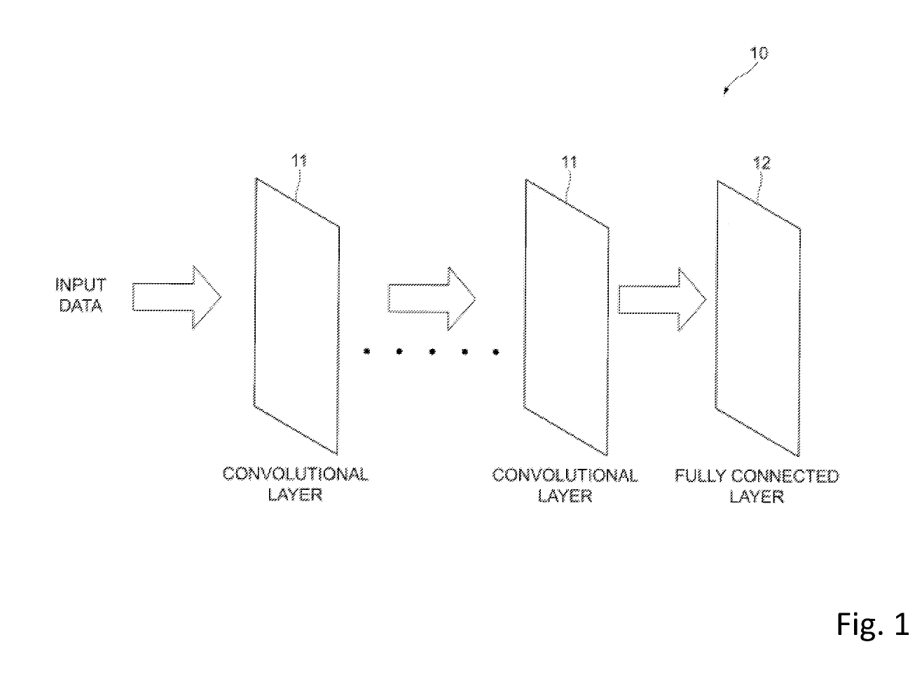

FIG. 1 depicts a configuration of convolutional neural networks 10 according to an exemplary embodiment of the present invention.

As shown in FIG. 1, the convolutional neural networks 10 includes convolutional layers 11 and a fully connected layer (FCL) 12.

Each convolutional layer 11 performs convolutional operation on input data to extract feature vectors regarding the input data. The fully connected layer 12 classifies the input data based on the feature vectors extracted by the convolutional layers 11.

This exemplary embodiment assumes a model of the convolutional neural networks 10 which consists of an input layer, intermediate layer(s) (hidden layer(s)), and an output layer. Only the intermediate layer(s) of this model is shown in FIG. 1.

Note that the convolutional neural networks 10 includes pooling layers (not shown in the figures) provided for respective convolutional layers 11 to reduce the size of data to be processed. Further, the convolutional neural networks 10 includes a single convolutional layer 11 instead of the multiple convolutional layers 11 as shown in FIG. 1.

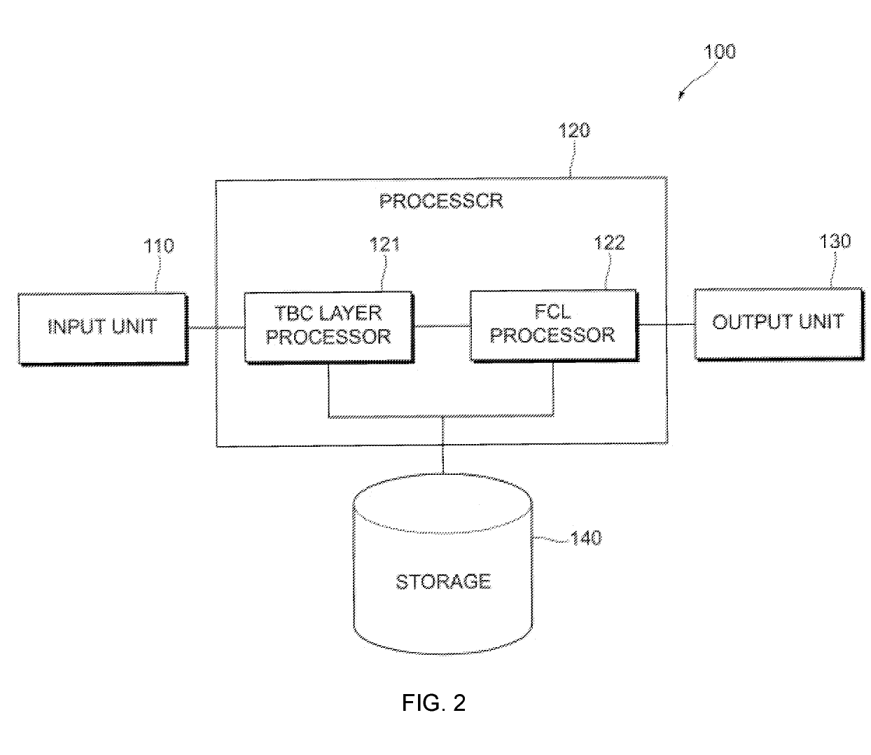

FIG. 2 depicts a block diagram showing a configuration of an information processing system 100 utilizing the convolutional neural networks 10 of FIG. 1.

As shown in FIG. 2, the information processing system 100 includes an input unit 110 that receives the input data to be processed, a processer 120 processing the input data, an output unit 130 outputting a processing result, and a storage 140 storing parameters, such as weights and bias parameters (described later).

The processor 120 may include a tree-based convolutional (TBC) layer processor 121 and a fully connected layer (FCL) processor 122.

In the information processing system 100, the input unit 110 corresponds to the input layer in the above mentioned model of the convolutional neural networks 10. The processor 120 corresponds to the intermediate layer(s) of the model. The output unit 130 corresponds to the output layer of the model. The tree-based convolutional layer processor 121 executes a process corresponding to the process performed by the convolutional layers 11 of FIG. 1. The fully connected layer processor 122 executes a process corresponding to the process performed by the fully connected layer 12.

In the present exemplary embodiment, the processor 120 uses tree-based convolutional neural networks (TBCNN). The TBCNN processes the input data having a tree structure. The TBCNN maps the feature vectors on each convolutional layer, i.e. tree-based convolutional (TBC) layer, without changing the form of the tree structure. In other words, the respective TBC layers generate feature maps having the same tree structure as the input data.

TBCNN enables training with tree structures that allows for the following. Firstly, each TBC layer takes a tree structure where nodes have feature vectors. Secondly, each node in a previous TBC layer is transformed to a node in the next TBC layer having features of the node and its descendants in the previous TBC layer with weight and bias parameters assigned to the node and the descendants. Finally, the last TBC layer can be connected to a fully connected layer by extracting the feature vectors of a root node in the last TBC layer.

The trees with the same structure are transformed to the same trees cause's problems in forward/backward computation with enormous data simultaneously. This can lead to a high computational cost and large memory consumption because the same calculation is performed again and again on subtrees having the same structure and the same feature vectors are stored in different memory areas.

In the present exemplary embodiment, the computational cost and/or the memory consumption may be reduced.

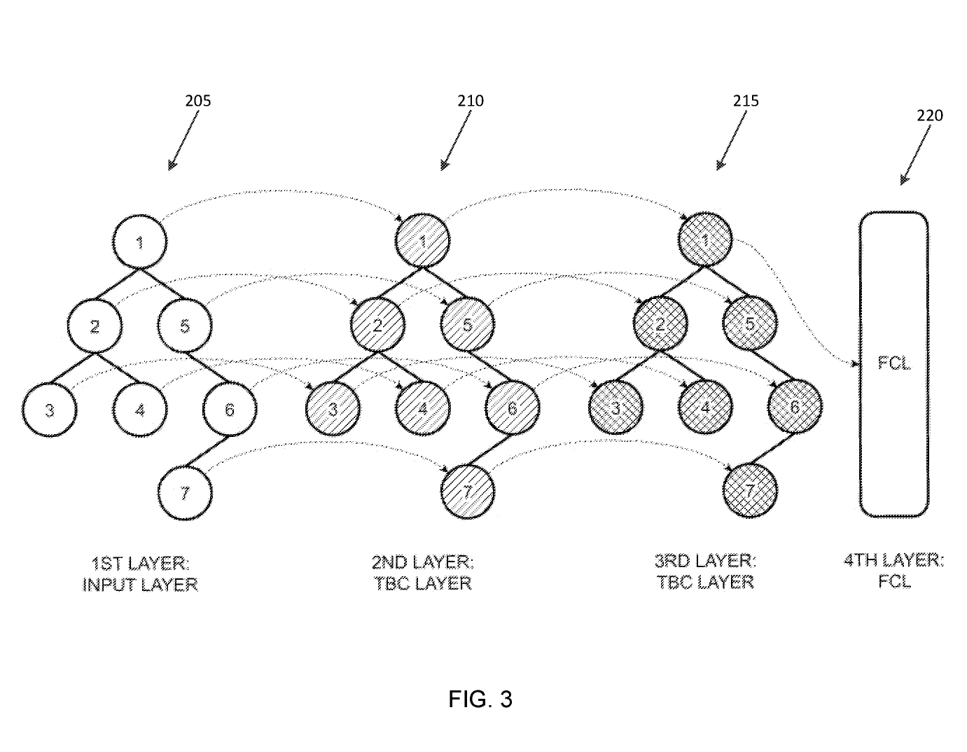

FIG. 3 depicts a configuration of the TBCNN.

The TBCNN shown in FIG. 3 includes the first layer 205, the second layer 210, the third layer 215 and the fourth layer 220. The first layer 205 in the shown example corresponds to the input layer in the above mentioned model. The second layer 210 and the third layer 215 respectively correspond to the TBC layers. In other words, the TBCNN of FIG. 3 includes two TBC layers. The fourth layer 220 corresponds to the fully connected layer. Note that each node of the second layer 210 includes two features and each node of the third layer 215 includes four features.

In the TBCNN, information on each node of the trees is embedded into respective feature vectors. Further, in the TBC layers which are consecutively arranged, feature vectors in the next TBC layer are calculated from feature vectors of the corresponding node and its descendant nodes in the previous TBC layer.

For example, feature vectors of a node 1 of the third layer 215 are calculated from feature vectors of the nodes of the second layer 210 and the weights and bias parameters assigned to the nodes. More specifically, the feature vectors of the node 1 of the third layer 215 are calculated from the feature vectors of a node 1, a node 2 and a node 5 of the second layer. For example, the feature vectors of the node 1 of the third layer 215 is obtained by multiplying the node 1, the node 2 and the node 5 of the second layer 210 by the respective weights and adding the respective biases to the node 1, the node 2 and the node 5. Note that the node 1 of the second layer 210 corresponds to a node of the previous TBC layer in the above explanation. The nodes 2 and 5 correspond to descendants, i.e. child nodes of the node 1.

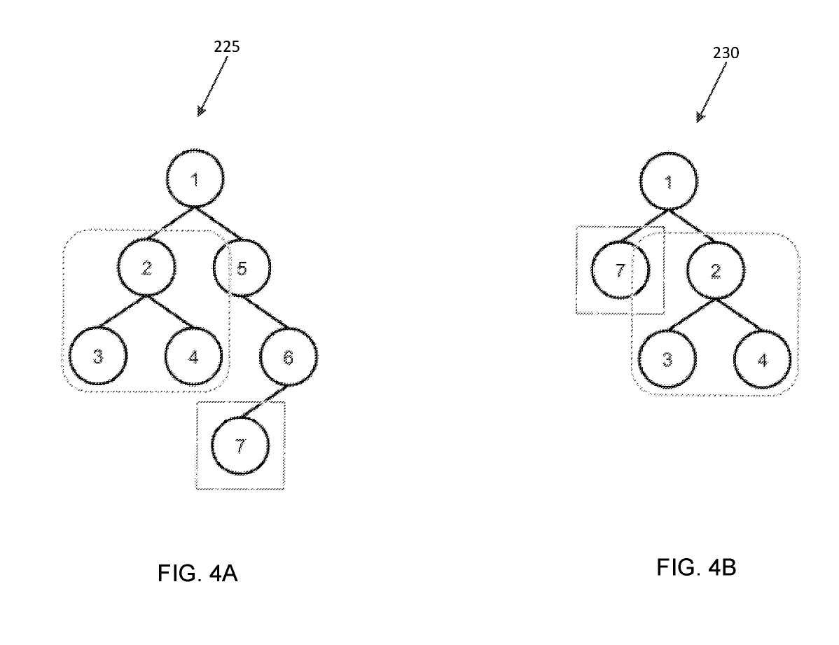

FIGS. 4A and 4B depict structures of the trees including the same subtree 225, 230.

In a process of analyzing multiple trees, i.e. in a calculation of respective feature vectors of each node included in the trees, the subtree included in at least two of the trees in common is repeatedly processed.

For example, assume the trees 225, 230 shown in FIGS. 4A and 4B where the tree 225 of FIG. 4A includes nodes 1 to 7 while the tree 230 of FIG. 4B includes nodes 1 to 4 and 7. Both trees 225, 230 of FIGS. 4A and 4B include the same subtree (common subtree, common elements) consisting of the node 2 as a parent node, the node 3 and the node 4 as child nodes, i.e. leaf nodes (refer to the subtree surrounded by a broken line). This causes that the common subtree is repeatedly processed in the respective analyses of the trees of FIGS. 4A and 4B.

Further, the trees of FIGS. 4A and 4B include the same leaf node, namely the node 7 (surrounded by a chain line). This also causes that the node 7 is repeatedly processed in the respective analyses of the trees 225, 230 of FIGS. 4A and 4B.

Such redundant processing on the common subtree increases the computational cost because the same calculation should be repeated. Further, multiple sets of the feature vectors of the common subtree are stored in different memory areas, which increases the memory consumption.

The present exemplary embodiment optimizes the TBCNN by a node-sharing of the node(s) included in the common subtree. Note that the optimization of the TBCNN is conducted as a pre-process on the trees before the tree-based convolutional layer processor 121 executes a process corresponding to the process performed by the convolutional layers 11 of FIG. 1. The node-sharing refers to combining multiple trees to generate one tree, i.e. a combined tree in such a way that subtrees of the combined tree share a node(s) that exists in common in at least two of the multiple trees before combining. Note that such a node existing in common in the multiple trees may be referred to as a common node.

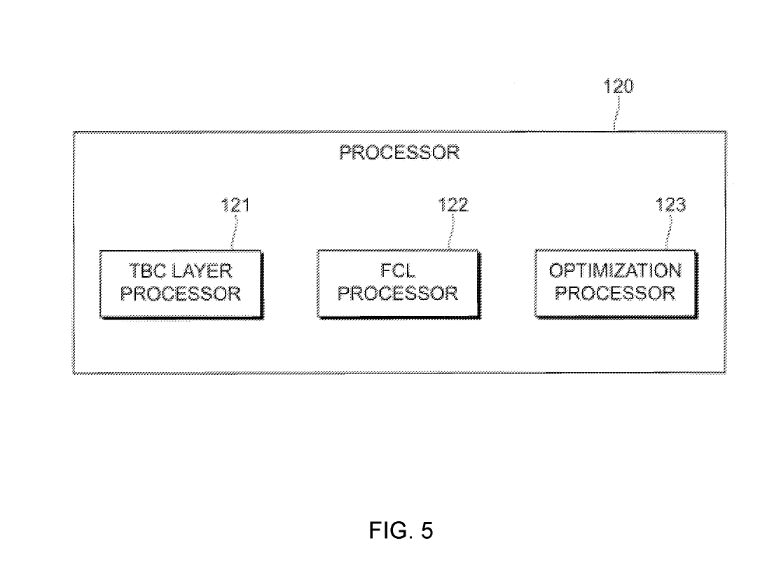

FIG. 5 depicts a block diagram showing a configuration of the processer 120. Although an explanation is omitted in the above, the processer 120 includes an optimization processor 123, as shown in FIG. 5, in addition to the above mentioned tree-based convolutional layer processor 121 and the fully connected layer processor 122. Note that the optimization processor 123 is an example of a first processor. The tree-based convolutional layer processor 121 is an example of a second processor. The fully connected layer processor 122 is an example of a third processor.

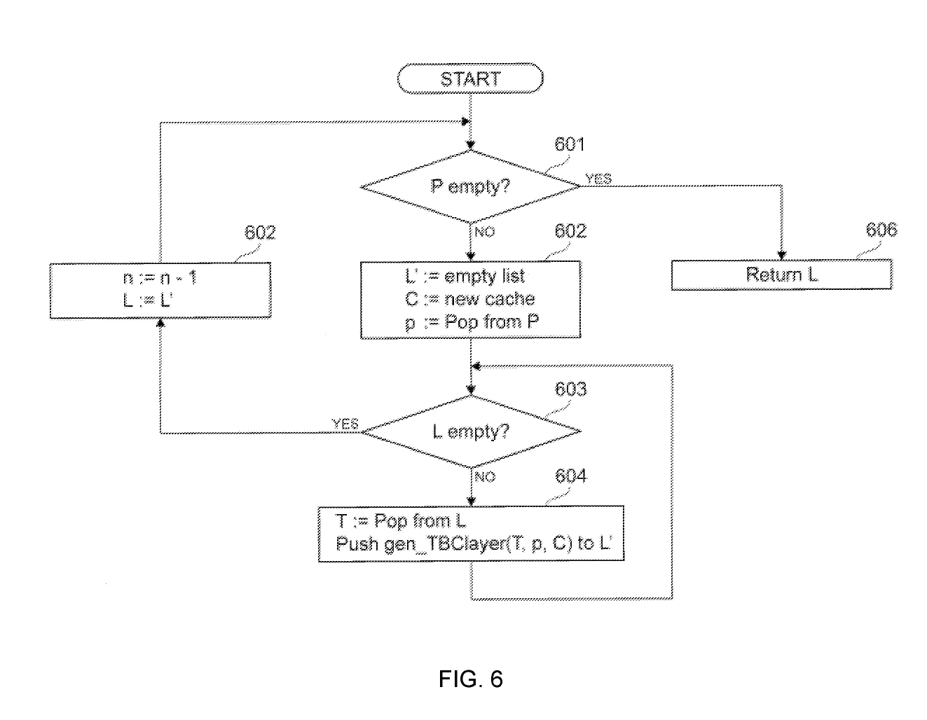

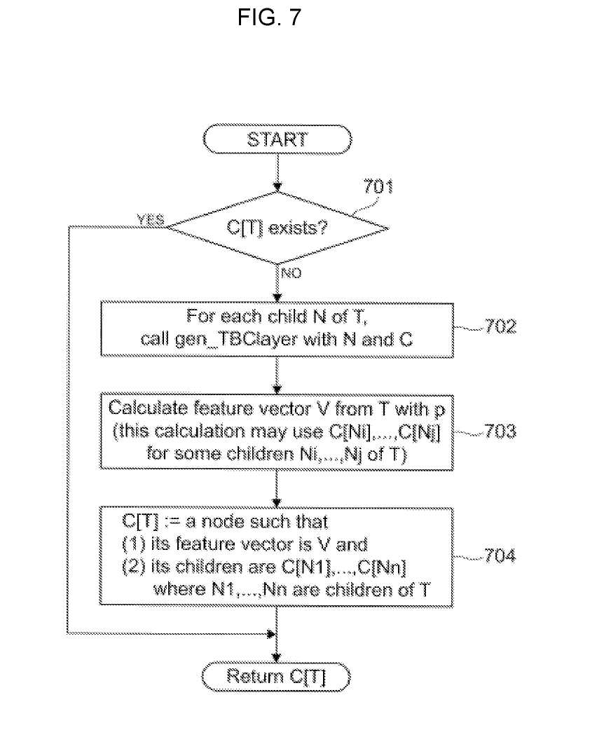

FIG. 6 is a flowchart of a process to generate the TBCNN. FIG. 7 is a flowchart of a process to generate a TBC layer.

FIGS. 6 and 7 illustrates a process for optimizing the TBCNN will be described. For example, analysis objects are assumed to be two trees (two input data) respectively having the tree structure of FIG. 4A and the tree structure of FIG. 4B. This process performs the node-sharing as to the common subtree of the given two trees and generates the TBC layers to have an optimized TBCNN.

In the main procedure, i.e. in the process to generate the TBCNN, inputs are a list of the trees to be processed L and a list of parameter sets P, and an output is the last TBC layer with shared nodes.

As shown in FIG. 6, the optimization processor 123 first determines whether the parameter sets P is empty (step 601). In other words, the optimization processor 123 determines whether there is no layer to be processed. When the parameter set P is not empty (No in step 601), the optimization processor 123 sets a provisional list L′ as an empty list, sets a cache C that temporarily stores the trees having been combined as a new cache, and sets a parameter set p popping from the parameter sets P (step 602).

The optimization processor 123 then determines whether the list of the trees L is empty (step 603). In other words, the optimization processor 123 determines whether there is no tree to be processed. If the list of the trees L is not empty (No in step 603), the optimization processor 123 sets a tree T popping from the list of the trees L and starts (pushes) to generate the TBC layer with the tree T, the parameter set p and the cache C, and sets the result to the provisional list L′ (step 604).

When the list of the trees L is empty (Yes in step 603), the optimization processor 123 sets the number of layers to be processed n as n-1 and sets the list of the trees L as the provisional list L′ (step 605).

When the parameter set is empty (Yes in step 601), the optimization processor 123 returns the list of the trees L (step 606).

In a sub procedure, i.e. in the process to generate the TBC layer, inputs are the tree T, the parameter set p, and the cache C, and an output is a directed acyclic graph (DAG) with the shared nodes. Further, this process ensures the cache C regarding the tree T (hereinafter referred to as a tree cache C[T]), as the output.

As shown in FIG. 7, the optimization processor 123 first determines whether the subject tree exists in a tree cache C[T] (step 701). In this step, the optimization processor 123 focuses on the root node of the subject tree as a target node, and determines whether the tree in the tree cache C[T] has the same structure as the subject tree.

When the subject tree does not exist in the tree cache C[T] (No in step 701), the optimization processor 123 suspends the process of generating the TBC layer and focuses on a child node below the root node in the subject tree to call a sub procedure, i.e. generate the TBC layer, recursively (step 702).

In this sub procedure, the optimization processor 123 determines whether the subtree including this child node as a parent node exists in the tree cache C[T]. The optimization processor 123 repeats the above process until the subject subtree is found in the tree cache C[T]. Note that if none of the subtrees has been found in the tree cache C[T], the optimization processor 123, in the sub procedure regarding a leaf node, adds information on this leaf node to the tree cache C[T] to resume the sub procedure regarding the parent node of this leaf node.

The optimization processor 123 then calculates a feature vector V from the subject tree T with the parameter set p (step 703). This calculation uses C[Ni], . . . , C[Nj] for some child nodes Ni, . . . , Nj of the subject tree T. The optimization processor 123 then sets the tree cache C[T] as a node such that (1) its feature vector is V and (2) its child nodes are C[N1], . . . , C[Nn] where N1, . . . , Nn are the child nodes of the subject tree T (step 704). In other words, the optimization processor 123 resumes the process of generating the TBC layer regarding the subtree after gaining the feature vectors regarding the child nodes.

Note that a direction of a search for the common subtree included in the subject tree is not limited to any direction. For example, the search may be a depth-first or a breadth-first search of the subject tree.

As described above, one tree is generated as the analysis object by combing multiple trees, i.e. all the trees to be processed.

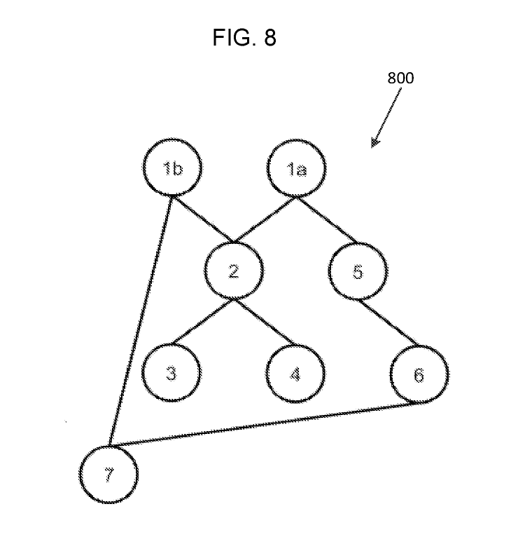

FIG. 8 depicts a structure of a tree 800 generated by combining the trees of FIGS. 4A and 4B.

As described above with reference to FIGS. 4A and 4B, the trees 225, 230 include the common elements, i.e. the subtree with the node 2 as the parent node, the nodes 3 and 4 as the child nodes, and the leaf node of the node 7. In this example, one tree is generated 800. The generated one tree 800 consists of all the elements of the trees 225, 230 before combining the trees 225, 230 while sharing the common elements.

Hereinafter, the tree 225 of FIG. 4A may be referred to as a “tree A”, the tree 230 of FIG. 4B may be referred to as a “tree B”, and the tree 800 of FIG. 8 may be referred to as a “tree C”.

As shown in FIG. 8, the tree C includes two root nodes, i.e. a node 1a and a node 1b. The two root nodes respectively correspond to the root nodes of the trees A and B, i.e. the node 1 of the trees A and B.

In the tree C, the node 1a is linked to a node 2 and a node 5, i.e. the node 1 has two child nodes. The node 2 is linked to a node 3 and a node 4, i.e. the node 2 has two child nodes. The node 3 and the node 4 are the leaf nodes, i.e. the nodes 3 and 4 have no child node. A node 5 is linked to a node 6, i.e. the node 5 has a child node. The node 6 is linked to a node 7, i.e. the node 6 has a child node. The node 7 is the leaf node.

That is, the tree C includes all the elements of the tree A. In other words, the structure of the subtree with the node 1a as its root node is the same as the structure of the tree A.

Here, in the tree C, the node 1b has two child nodes, i.e. the node 2 and the node 7. The node 2 has two child nodes, i.e. the node 3 and the node 4. The node 3, the node 4, and the node 7 are the leaf nodes.

As mentioned above, the tree C includes all the elements of the tree B. In other words, the structure of the subtree with the node 1b as its root node is the same as the structure of the tree B.

Treating the tree C as the analysis object of the TBCNN, in other words, analyzing the tree C with the TBCNN may be the same analysis as analyzing the tree A and the tree B respectively with the TBCNN.

Note that the tree C includes two root nodes, i.e. the node 1a and the node 1b. Further, the node 2 and the node 7 respectively have two parent nodes. In that sense, the tree C may not have an exact tree structure. However, the tree C has a structure generated by combing the tree A and the tree B, and the tree C can be the analysis object with the TBCNN, so that the tree C may be treated as a tree in the present exemplary embodiment.

Here, in the tree C, the subtree consisting of three nodes, i.e. the node 2, the node 3, and the node 4, is shared by the subtree including the node 1a as the root node and the subtree including the node 1b as the root node. Similarly, in the tree C, the node 7 is shared by the subtree including the node 1a as the root node and the subtree including the node 1b as the root node. Analyzing the tree C instead of analyzing the trees A and B respectively may eliminate the need to repeat the process of the TBC layer as to the nodes 2, 3, 4, and 7. This enables to reduce the computational cost to repeat the same calculation. This also enables to reduce the memory consumption to store the same feature vectors in different memory areas.

In the above explanation, two trees (trees A and B) are combined together to generate one tree (tree C). Three or more trees may be combined together to reduce the computational cost and the memory consumption. That is to say, if the common elements (the common subtree) are shared by different trees, the computational cost and the memory consumption can be reduced by the number of trees sharing the common elements.

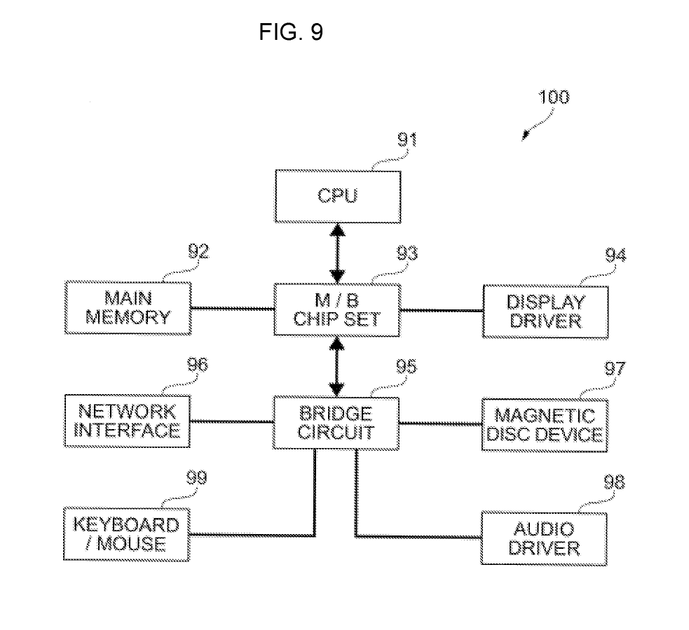

Referring to FIG. 9, there is shown an example of a hardware configuration of the information processing system 100. As shown in the figure, the information processing system 100 may include a central processing unit (CPU) 91, a main memory 92 connected to the CPU 91 via a motherboard (M/B) chip set 93, and a display driver 94 connected to the CPU 91 via the same M/B chip set 93. A network interface 96, a magnetic disk device 97, an audio driver 98, and a keyboard/mouse 99 are also connected to the M/B chip set 93 via a bridge circuit 95.

In FIG. 9, the various configurational elements are connected via buses. For example, the CPU 91 and the M/B chip set 93, and the M/B chip set 93 and the main memory 92 are connected via CPU buses, respectively. Also, the M/B chip set 93 and the display driver 94 may be connected via an accelerated graphics port (AGP). However, when the display driver 94 includes a PCI express-compatible video card, the M/B chip set 93 and the video card are connected via a PCI express (PCIe) bus. Also, when the network interface 96 is connected to the bridge circuit 95, a PCI Express may be used for the connection, for example. For connecting the magnetic disk device 97 to the bridge circuit 95, a serial AT attachment (ATA), a parallel-transmission ATA, or peripheral components interconnect (PCI) may be used. For connecting the keyboard/mouse 99 to the bridge circuit 95, a universal serial bus (USB) may be used.

For example, the CPU 91 may perform functions of the input unit 110, the processer 120, and the output unit 130. The main memory 92 and the magnetic disk device 97 may perform functions of the storage 140.

Note that the information processing system 100 may be configured by a single computer. Alternatively, the information processing system 100 may be distributed in multiple computers. Further, a part of the function of the information processing system 100 may be performed by servers on the network, such as a cloud server.

Here, the above tree is a sort of a directed acyclic graph (DAG). Further, as mentioned above, the tree shown in FIG. 8 generated by combing multiple trees may not have an exact tree structure. The tree shown in FIG. 8 is a DAG itself. It is therefore the above mentioned exemplary embodiment is applicable to not only the information processing system 100 for analyzing data having the tree structure but also an information processing system for analyzing DAGs.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A computer-implemented method for optimizing neural networks for receiving a plurality of input data, comprising;
finding a common node included in at least two of a plurality of input data having a form of a tree having subtrees, wherein the at least two of the plurality of input data include the common node, wherein the neural networks comprise convolutional layers, wherein the finding the common node is performed for each convolutional layer; and
reconstructing the tree to represent the plurality of input data, wherein the reconstructed tree includes sharing the common node, wherein the reconstructing the plurality of input data is performed for each convolutional layer, wherein the reconstructing tree is performed in such a way that subtrees of the combined tree share a node that exists in common in at least two of the multiple trees before reconstructing.
